(19) United States
(12) Patent Application Publication
(10) Pub. No.: US 2024/0019844 A1
(43) Pub. Date: Jan. 18, 2024

(54) CONTROLLER BASED ON EMPIRICAL MODEL

(71) Applicants: Advanced Energy Industries, Inc., Denver, CO (US); Colorado State University Research Foundation, Fort Collins, CO (US)

(72) Inventors: Chad S. Samuels, Fort Collins, CO (US); Peter Young, Fort Collins, CO (US)

(21) Appl. No.: 17/867,671

(22) Filed: Jul. 18, 2022

(51) Int. Cl. G05B 19/4155

(52) U.S. Cl. CPC G05B 19/4155

(57) ABSTRACT

This disclosure describes systems, methods, and apparatus for a distributed controller. The distributed controller can include a traditional closed or open loop feedback controller followed by an empirically derived mapping that converts the controller output to a modified output, where the controller optimizes stability and the empirically derived mapping optimizes performance. The empirically derived mapping can be formed of coefficients representing linear controllers at inflection points, where the linear controllers are inversely related to a system model. The system model can comprise a static linear model, a dynamic linear model, and a total uncertainty. The static linear model can be derived from large signal steady state analysis, the dynamic nonlinear model can be derived from small signal transient analysis, and the uncertainty can be derived from small signal steady state analysis.

### FIELD OF THE DISCLOSURE

The present disclosure relates generally to controller design. In particular, but not by way of limitation, the present disclosure relates to systems, methods and apparatuses for designing a controller using empirical analysis to develop a static nonlinear portion, a dynamic linear portion, and an uncertainty portion of a system model.

### DESCRIPTION OF RELATED ART

Control systems have important applications in many technology areas, including plasma applications, semiconductor processing and other materials processing, robotics, vehicle control systems for automobiles, aircraft, and spacecraft, and other electronic, manufacturing, and industrial systems. Semiconductor processing and other advanced materials processing rely on increasingly sophisticated plasma processes. Such plasma processes, in turn, require increasingly sophisticated power systems and control systems, to subject inherently unstable and nonlinear plasmas to increasing precision and consistency. Such plasmas are used for processes such as plasma etch processes, plasma-enhanced chemical vapor deposition (CEPVD) processes, plasma-enhanced atomic layer deposition (PEALD) processes, plasma-assisted atomic-layer deposition (PA-ALD), RF sputtering deposition, and other plasma processing applications.

Plasmas are nonlinear loads that tend to see dynamic and unpredictable changes to parameters such as impedance as recipes progress. Traditional feedback systems are inoperable relative to strongly nonlinear and/or chaotic loads. Thus, many previous efforts have focused on controlling power delivery to these nonlinear and sometimes chaotic loads, and on achieving both robust delivery as well as rapid convergence on a desired output parameter. Many of these controllers can achieve these goals, but only with extreme processing resources, that are not always available in practice or in legacy power delivery hardware. Thus, there is a need for robust and rapidly converging control of power systems for plasma processing that reduces processing requirements over known control systems.

### SUMMARY OF THE DISCLOSURE

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

In some aspects, the techniques described herein relate to a generator including: a power generation section; a match network coupled to an output of the power generation section; and a distributed controller configured to receive a target waveform and feedback from sensors at or downstream from the power generation section and/or the match network, the distributed controller including: a controller configured to generate a control; and an empirically derived mapping between an output of the controller and a modified control to be provided to the power generation section, the empirically derived mapping being an inverse of a system model including: a static nonlinear model; a dynamic linear model; and a total uncertainty.

In some aspects, the techniques described herein relate to a generator, wherein the controller uses closed loop feedback from the sensors and increases or decreases an output of the power generation section based on the closed loop feedback.

In some aspects, the techniques described herein relate to a generator, wherein the controller forms an open loop system and reduces or cuts off an output of the power generation section if feedback from the sensors meets or exceeds a threshold.

In some aspects, the techniques described herein relate to a generator, wherein the static nonlinear model is derived from large signal steady state analysis.

In some aspects, the techniques described herein relate to a generator, wherein the dynamic linear model is derived from small signal transient analysis.

In some aspects, the techniques described herein relate to a generator, wherein the small signal transient analysis includes: applying perturbations around a series of setpoints; measuring first transient responses to the first perturbations; identifying inflection points in the first transient responses; applying perturbations around the inflection points; measuring second transient responses to the second perturbations; building the dynamic linear model by fitting the second transient responses to transfer functions.

In some aspects, the techniques described herein relate to a generator, wherein the inflection points are identified by (1) comparing a derivative of the control resulting from the perturbations around the series of setpoints with respect to the setpoint to a threshold, when linear interpolation between inflection points is used, or (2) comparing the derivative of the control resulting from the perturbations around the series of setpoints with respect to the setpoint to a function, when nonlinear interpolation between inflection points is used.

In some aspects, the techniques described herein relate to a generator, wherein the total uncertainty includes (1) an input uncertainty developed by applying control signals corresponding to repeated perturbed setpoints, corresponding to the inflection points, to the power generator section and characterizing the input uncertainty from first resulting measurements, and (2) an output uncertainty developed by generating control signals from the controller corresponding to the setpoints, corresponding to the inflection points, and injecting a perturbation atop the control signals and characterizing the output uncertainty from second resulting measurements.

In some aspects, the techniques described herein relate to a generator, wherein the total uncertainty includes (1) an input uncertainty developed by applying control signals corresponding to repeated perturbed setpoints to the power generator section and characterizing the input uncertainty from first resulting measurements, and (2) an output uncertainty developed by generating control signals from the controller corresponding to the setpoints and injecting a perturbation atop the control signals and characterizing the output uncertainty from second resulting measurements.

In some aspects, the techniques described herein relate to a method of creating a distributed controller, the method including: iterating through a series of steady state measurements for setpoints of a power generation section to give a static nonlinear model of the system; iterating through transient analysis of the setpoints, or inflection points identified in the static nonlinear model of the system, to give a dynamic linear model of the system, and for each transient iteration: applying a small signal perturbation to the power generation section around a selected one of the setpoints or inflection points; measuring a resulting transient signal as a function of time; fitting the resulting transient signal to a transfer function; building the dynamic linear model of the system with the transfer function; iterating through a series of uncertainty measurements to give a total uncertainty of the system, wherein combining the static nonlinear model of the system, the dynamic linear model of the system, and the total uncertainty to form a system model underlying operation of the distributed controller.

In some aspects, the techniques described herein relate to a method, further including taking an inverse of the system model to obtain a set of linear controllers around the inflection points, and storing coefficients of the linear controllers as a mapping that the distributed controller is configured to call on during operation.

In some aspects, the techniques described herein relate to a method, wherein when operation of the distributed controller calls for a mapping between the stored coefficients or inflection points, interpolation is used to expand the mapping.

In some aspects, the techniques described herein relate to a method, further including building the dynamic linear model of the system via interpolation.

In some aspects, the techniques described herein relate to a method, further including inflection point optimization including compression of the dynamic linear model.

In some aspects, the techniques described herein relate to a method of creating a distributed controller, the method including: iterating through steady state measurements of a power generation section based on a series of setpoints to give a static nonlinear model of the system; using the setpoints to identify inflection points of a derivative of the control with respect to a corresponding setpoint; iterating through transient measurements of the power generation section based on a series of perturbations applied at the inflection points to give a dynamic linear model of the system; iterating through uncertainty measurements for each of the inflection points to give a total uncertainty formed from an input uncertainty and an output uncertainty calculating the total uncertainty from input and output uncertainties for the inflection points, wherein the distributed controller includes coefficients of linear controllers around the inflection points, where the linear controllers are found as an inverse of a system model including the static nonlinear model of the system, the dynamic linear model of the system, and the total uncertainty.

In some aspects, the techniques described herein relate to a method, wherein iterating through the uncertainty measurements includes for each one of the inflection points: perturbing one of the setpoints corresponding to one of the inflection points and applying a corresponding first control signal n times to the power generation section; measuring a parameter of an output of the power generation section as a function of time for each of the n corresponding first control signals to give n first measurements; characterizing the input uncertainty for the one of the setpoints corresponding to one of the inflection points as a variance in the n measurements of the parameter of the output of the power generation section; applying a second control signal for one of the setpoints corresponding to the one of the inflection points and performing n identical perturbations of the second control signal; measuring a parameter of an output of the power generation section as a function of time for each of the n perturbed second control signals to give n second measurements; and characterizing the output uncertainty for the one of the setpoints corresponding to one of the inflection points as a variance in the n second measurements.

In some aspects, the techniques described herein relate to a method, wherein calculating the total uncertainty includes: where a and b are weights applied to the input and output uncertainty, respectively.

In some aspects, the techniques described herein relate to a method, wherein the calculating the total uncertainty includes: where a and b are weights applied to the input and output uncertainty, respectively.

In some aspects, the techniques described herein relate to a generator including: a power generation section configured to apply an output signal to a load responsive to a setpoint; one or more sensors coupled to, or coupled to an output of, the power generation section; and a distributed controller including one or more processing portions, one or more memories, and one or more modules stored on the one or more memories and executable on the one or more processing portions to: convert the setpoint to a control signal via a controller, such that the output signal is stable; and convert the control signal to a modified control signal via an empirically derived mapping between the control signal and a modified control signal and provide the modified control signal to the power generation section, such that the output signal rapidly converges to the setpoint.

In some aspects, the techniques described herein relate to a generator, wherein the empirically derived mapping is an inverse of a system model including: a static nonlinear model; a dynamic linear model; and a total uncertainty.

In some aspects, the techniques described herein relate to a generator, wherein the static nonlinear model is derived from iteratively applying different setpoints to the power generation section, waiting for the output signal to reach a steady state, and then measuring a parameter of the output signal, thereby forming a mapping between setpoints and the output signal in steady state.

In some aspects, the techniques described herein relate to a generator, wherein the dynamic linear model is derived from: iteratively applying a small signal perturbation around the different setpoints to the power generation section; measuring first transient responses; identifying inflection points in the first transient responses; removing from memory portions of the first transient responses that are not adjacent to an inflection point; iteratively applying the small signal perturbation around the inflection points; measuring second transient responses; fitting the second transient responses to transfer functions to build the dynamic linear model.

### BRIEF DESCRIPTION OF THE DRAWINGS

Various objects and advantages and a more complete understanding of the present disclosure are apparent and more readily appreciated by referring to the following detailed description and to the appended claims when taken in conjunction with the accompanying drawings:

FIG. 1 illustrates a system level diagram of the distributed controller in a plasma processing system;

FIG. 2 presents one non-limiting implementation of the distributed controller for controlling a DC/rail driver and an RF driver for a plasma processing system;

FIG. 3 illustrates details of the distributed controller;

FIG. 4 illustrates an alternative to FIG. 3 using a boundary controller;

FIG. 5 illustrates a detailed implementation of an empirically derived mapping;

FIG. 6 illustrates a method of creating a distributed controller;

FIG. 7 presents possible additional details of development of the dynamic linear model;

FIG. 8 illustrates another embodiment of a method for creating a distributed controller;

FIG. 9 illustrates an embodiment of a method for creating a system model focusing on details of the static nonlinear model;

FIG. 10 illustrates the embodiment of FIG. 9 showing details of the dynamic linear model;

FIG. 11 illustrates the embodiment of FIG. 9 showing details of the uncertainty determination; and

FIG. 12 illustrates a block diagram depicting physical components that may be utilized to realize the distributed controller (and the controller section generally) according to an exemplary embodiment.

### DETAILED DESCRIPTION

To overcome the challenges of controlling power delivery to plasma loads, the present disclosure describes systems, methods, and apparatus for a distributed controller. The distributed controller can include a traditional closed loop feedback controller, or an open loop feedback controller, either providing a control signal to an empirically derived mapping that converts the control signal to a modified control signal. The modified control signal, rather than the control signal, is provided to one or more actuators of a power generation system, that may include, for instance, a power amplifier or variable capacitors of a match network between the power amplifier and the plasma load. The empirically derived mapping is largely pre-calculated before a plasma processing recipe is run, and thus modified control signals can be identified based on a setpoint and feedback from the power generation section, in near real-time and using much lower processing resources than existing control systems.

The word “exemplary” is used herein to mean “serving as an example, instance, or illustration.” Any embodiment described herein as “exemplary” is not necessarily to be construed as preferred or advantageous over other embodiments.

Preliminary note: the flowcharts and block diagrams in the following Figures illustrate the architecture, functionality, and operation of possible implementations of systems, methods and computer program products according to various embodiments of the present disclosure. In this regard, some blocks in these flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present disclosure.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items, and may be abbreviated as “/”.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Overview of the Plasma Processing System

The plasma processing system 100 includes a power generation system 102 that can provide a multi-level pulsed waveform, or any arbitrary waveform, to a nonlinear plasma load 104 based on a user-defined power output or target waveform 106 (in other words, setpoints). The power generation system (or “generator” for short) 102 can include a user interface 108, an optional master control unit (MCU) 110, a control section (e.g., an FPGA) 112, and power generation and sensors 114 (or a “power generation section”). A match network 116 can be arranged within the generator 102 (as shown) or outside the generator 102. A distributed controller can be implemented as part of the control section 112 and can include a controller and an empirically derived mapping.

A user desired power output, or target waveform, is provided to a user interface 108, which is optionally adjusted by a microcontroller unit (MCU) 110 to help with average power tracking, and passed to a control section 112 as a setpoint stream. The MCU 110 can be used for relatively slow, high-level processing and complex algorithms, while the control section 112 can be implemented in an FPGA or other high-speed electronics and handles simple control algorithms. Thus, where the MCU 110 is implemented, a two-loop control approach can be used with a fast inner loop implementing simple control algorithms, and more complex processes running on the slower outer loop. In some embodiments, the optimized controllers disclosed herein can alleviate the need for the MCU 110, in which case the target waveform can be provided directly to the control section 112.

The control section 112 can use real-time measurements to perform real-time setpoint tracking, thereby constituting the fast inner loop of the feedback control system. The control section 112 can also perform averaging of the feedback and provide the averaged measurements back to the MCU 110. The MCU 110 may use a proportional-integral-derivative controller. The MCU 110 can use the averaged feedback to modify the user-defined setpoint values, passing these modified values to the control section 112. The MCU 110 can be continuously updated with the goal of matching the average power delivered to the target waveform. The MCU 110 can be tailored to make the average power track a second order critically damped system. In other embodiments, the MCU 110 is not implemented.

The control section 112 can use a multilevel pulsing algorithm for rail and drive/phase voltage. The goal of the algorithm is to minimize fluctuations in rail voltage, while keeping the value as low as possible, subject to keeping the drive/phase voltage close to its desired reference (or threshold) value. To implement this multilevel pulsing algorithm, the control section 112 can include controllers for rail voltage and drive/phase voltage. The distributed controller 150 can reside within this control section 112, receive feedback from sensors in the power generation and sensors 114 and can help provide real-time control of the rail voltage and drive/phase voltage. These voltages are provided by a DC section and a power amplifier in the power generation and sensors 114. The DC section provides a rail voltage to the power amplifier, which provides granular adjustments to power output to track the target waveform (e.g., a pulsed multi-level waveform). A match network 116 can be arranged between the power generation and sensors 114 and a nonlinear and possibly chaotic plasma load 104 to enhance the efficiency of power delivery to the nonlinear plasma load 104. Although the match network 116 is shown within the power generation system 102, in other embodiments, it can be arranged between the power generation system 102 and the nonlinear plasma load 104. The distributed controller can be found via method 600 or 800 as discussed below.

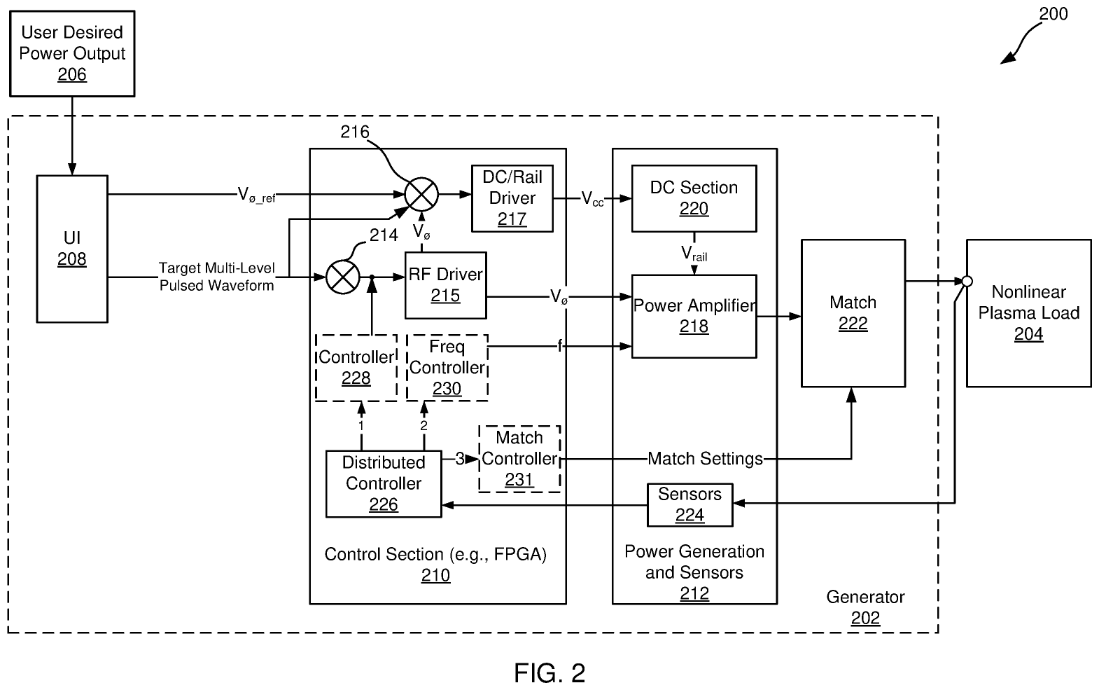

FIG. 2 presents one non-limiting implementation of the distributed controller for controlling a DC/rail driver and an RF driver for a plasma processing system. The distributed controller 226 designed by the method 600 or 800 (discussed below) can be implemented as a filter to an optional integrator 228, or where an integrator 228 is not used, the distributed controller 226 can directly control an RF driver 215 in concert with a target multi-level pulsed waveform provided by the user through a user interface 206. Alternatively or additionally, the distributed controller 226 can control an optional frequency controller 230, which provides frequency commands to a power amplifier 218. Alternatively or additionally, the distributed controller 226 can control an optional match network controller 231, which provides match settings to the match network 222.

The UI 208 provides a phase/drive threshold or reference voltage, V_{ø_ref}, selected by the user as well as a target multi-level pulsed waveform to the control section 210. A “target waveform” will be used interchangeably with target multi-level pulsed waveform. The control section 210 includes controllers 214 and 216 as well as the RF driver 215 and a DC/rail driver 217. The distributed controller 226 provides feedback control from sensors 224 as either a standalone controller or as a filter to another controller such as 228. The feedback takes measurements from the match network 222 output (or the chamber or nonlinear plasma load 204 or chamber input) through the distributed controller 226. The RF driver 215 provides a phase/drive control signal, V_{ø} to a power amplifier 218 of the power generation and sensors 212, while the DC/rail driver 217 provides a rail voltage control signal, V_{CC}, to the DC section 220. The DC section 220 provides the rail voltage, Vᵣₐᵢₗ, to the power amplifier 218 that then uses the rail voltage, Vᵣₐᵢₗ, to track the target waveform and provide an output to the match network 222.

For the purposes of this disclosure, a nonlinear plasma load can be weakly nonlinear, strongly nonlinear, chaotic, or strongly nonlinear and chaotic. Traditional feedback systems are inoperable relative to strongly nonlinear and/or chaotic loads.

### Details of the Distributed Controller

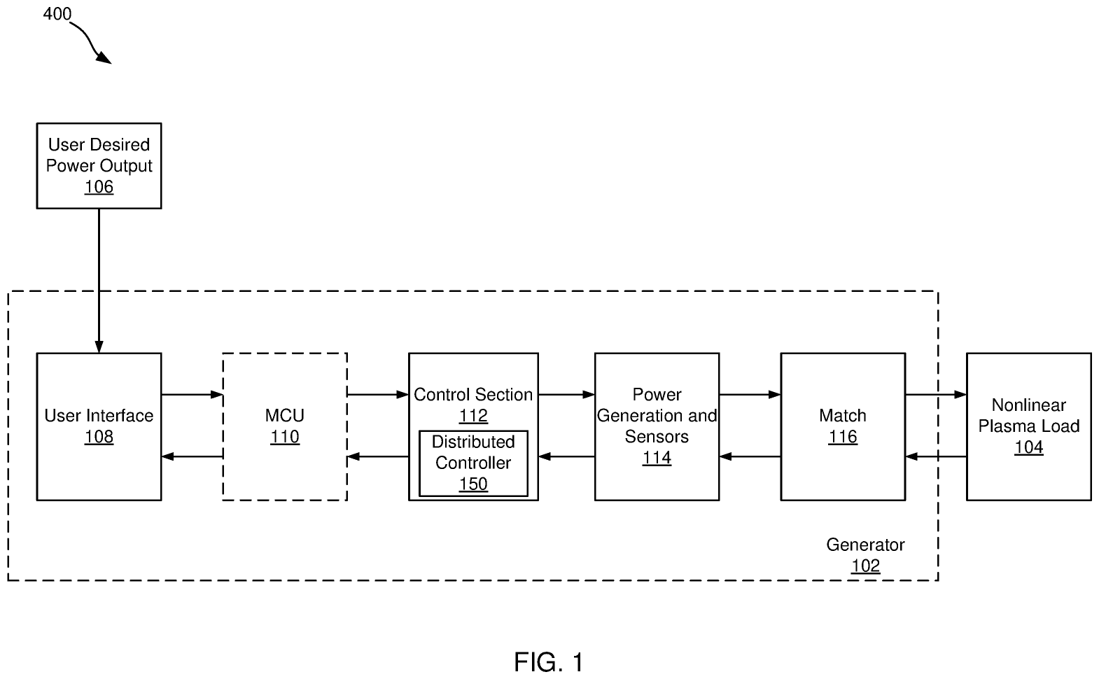

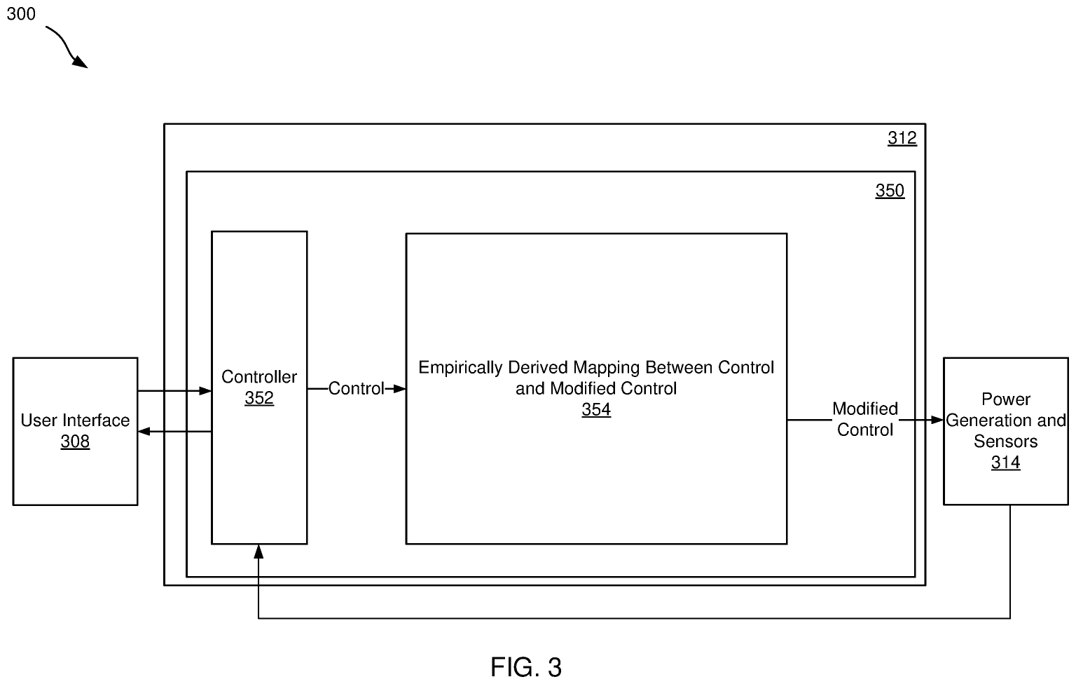

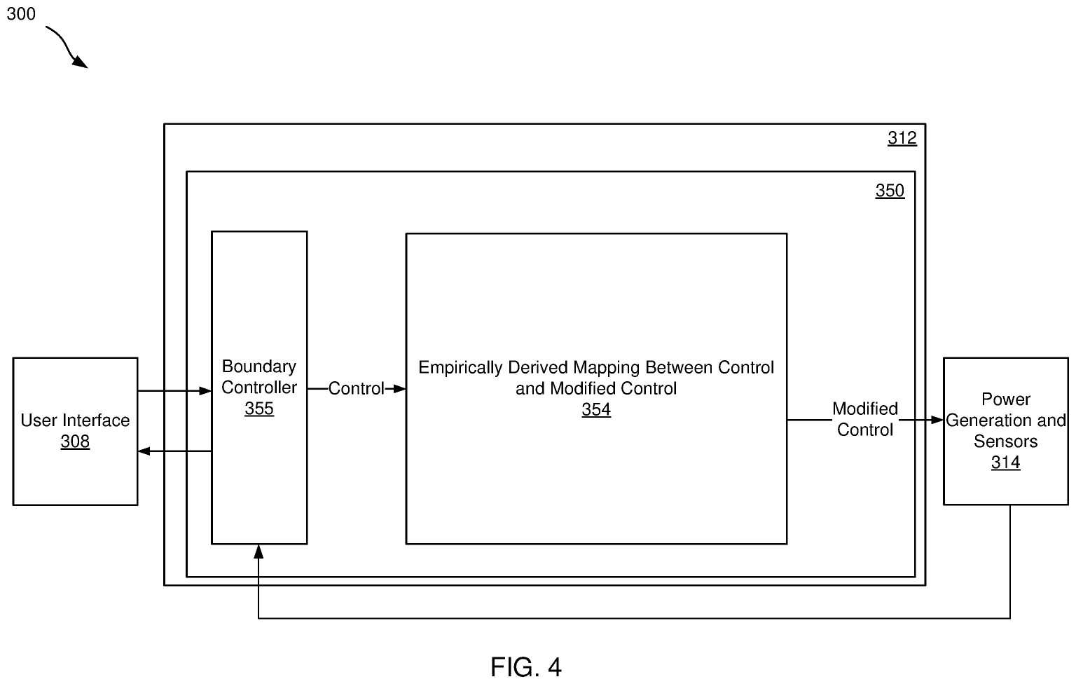

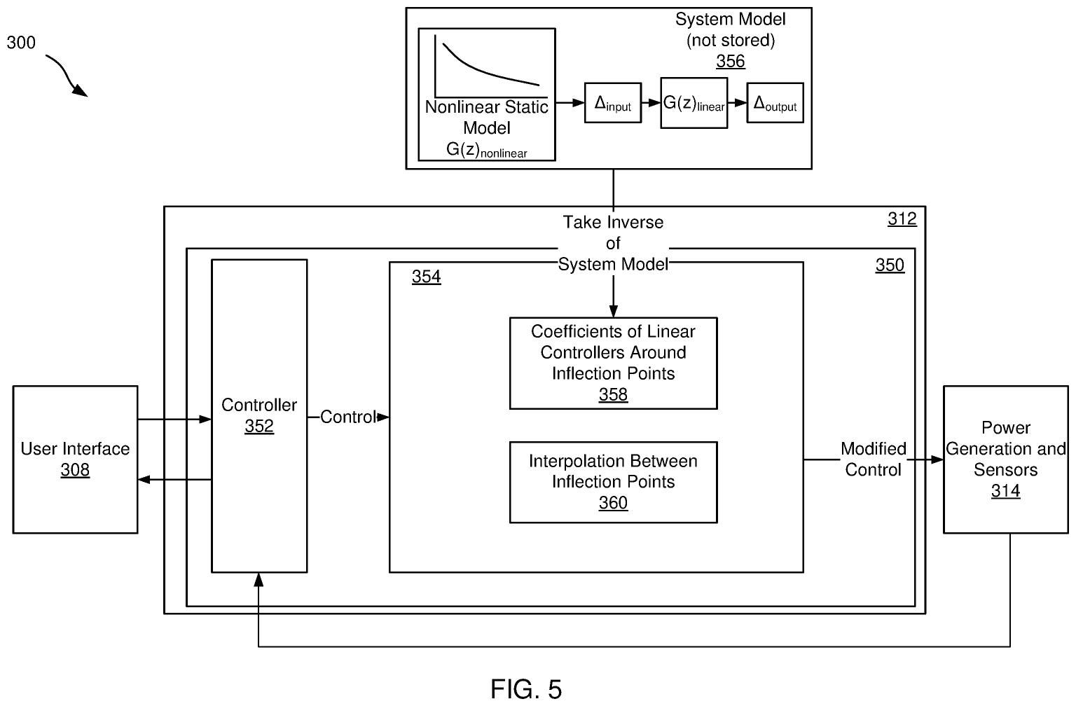

FIG. 3 illustrates details of the distributed controller of FIG. 1. The generator 300 includes a user interface 308, a power generation section 314, and a control section 312 having a distributed controller 350. The generator 300 can optionally also include a match network (not shown). The distributed controller 350 is configured to receive a target waveform from the UI 308 and feedback from sensors 314 at or downstream from the power generation section 314 and/or the match network (not shown). The distributed controller 350 can include a controller 352, such as a traditional controller with closed loop feedback from the power generation and sensor 314. The controller 352 can be configured to generate a control, that in a traditional control section 312, would be provided to the power generation and sensors 314. However, here, the control is modified en route to the power generation and sensors 314 by an empirically derived mapping between control and modified control 354 (or the “empirically derived mapping).” In a variation, the controller 352 can be replaced with a boundary controller (see 355 in FIG. 4), that is an open loop controller that cuts off or reduces the power generation section 314 output when internal metrics exceed a threshold (e.g., dissipated power, dc power, Total Dissipated Power (TDP), heat, Amplifier dissipated power). Either open or closed loop controller provides a control that is received by the empirically derived mapping 354 and adjusted or modified to achieve a control that delivers a more robust and mor rapidly converging output from the power generation and sensors 314. The empirically derived mapping 354 can include coefficients of linear controllers around inflection points as seen in 358 in FIG. 5 as well as an interpolation function 360 for identifying outcomes that are not adjacent to the inflection points (i.e., interpolating coefficients between the coefficients 358). These linear controllers are representative of a system model 356, but to preserve resources, the entire system model 356 is not stored in a memory of the distributed controller 350. Instead, the system model 356 is developed pre-runtime (e.g., at the factory or at a customer site before plasma processing begins) and then converted to the coefficients of linear controllers 358 for storage and runtime processing. Effectively, a compressed version of the system model 356 is stored as the coefficients 358 along with the interpolation function 360. In a simplified sense, the coefficients of linear controllers 358 around the inflection points are an inverse of the system model 356.

The system model 356 include a static nonlinear model, G₀(z)ₙₒₙₗᵢₙₑₐᵣ, a dynamic linear model, G₀(z)ₗᵢₙₑₐᵣ, and a total uncertainty, Δ. The total uncertainty can be made up of an input uncertainty, Δᵢₙ, and an output uncertainty, Δₒᵤₜ. The static nonlinear model, G₀(z)ₙₒₙₗᵢₙₑₐᵣ, can be derived from large signal steady state analysis of the controller 352 or boundary controller 355, and the power generation section 314, in a pre-runtime development phase. The static nonlinear model, G₀(z)ₙₒₙₗᵢₙₑₐᵣ, is a linear transfer function describing output(z)/input(z). Nonlinearity is achieved by having different G₀(z)ₙₒₙₗᵢₙₑₐᵣ for different setpoint values. The dynamic linear model, G₀(z)ₗᵢₙₑₐᵣ, can be derived from small signal transient analysis of the controller 352 or boundary controller 355, and the power generation section 314, in a pre-runtime development phase. By small signal it is meant that perturbations are less than 5% of the setpoint value being perturbed. The input uncertainty, Δᵢₙ, and an output uncertainty, Δₒᵤₜ, can be derived from small signal steady state analysis of the controller 352 or boundary controller 355, and the power generation section 314, in a pre-runtime development phase.

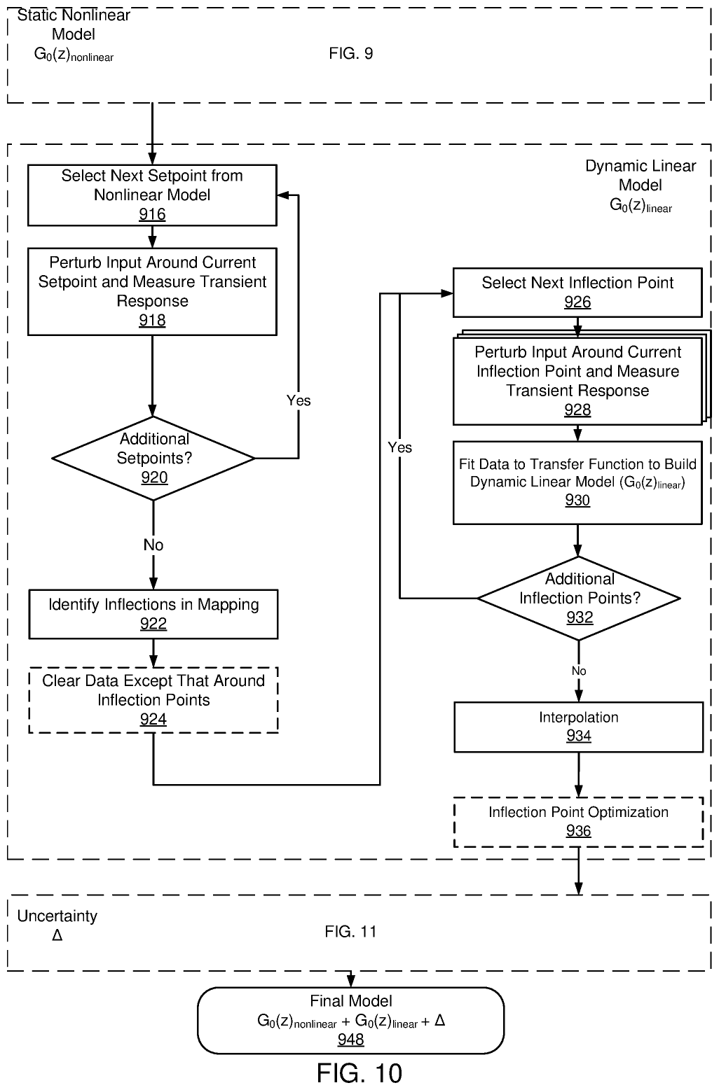

The small signal transient analysis can include applying perturbations around a series of setpoints; measuring first transient responses to the first perturbations; identifying inflection points in the first transient responses; applying perturbations around the inflection points; measuring second transient responses to the second perturbations; building the dynamic linear model by fitting the second transient responses to transfer functions (see Blocks 916-932 in FIG. 10). Characterizing the transient of the system can be written as Go(z)linear=Go(z)nonlinear−(Output_new(z)/Input_perturbed(z)), where input_perturbed(t)=1.05*setpoint(t) and Output_new(t) is the measured output after applying the input perturbation input_perturbed(t).

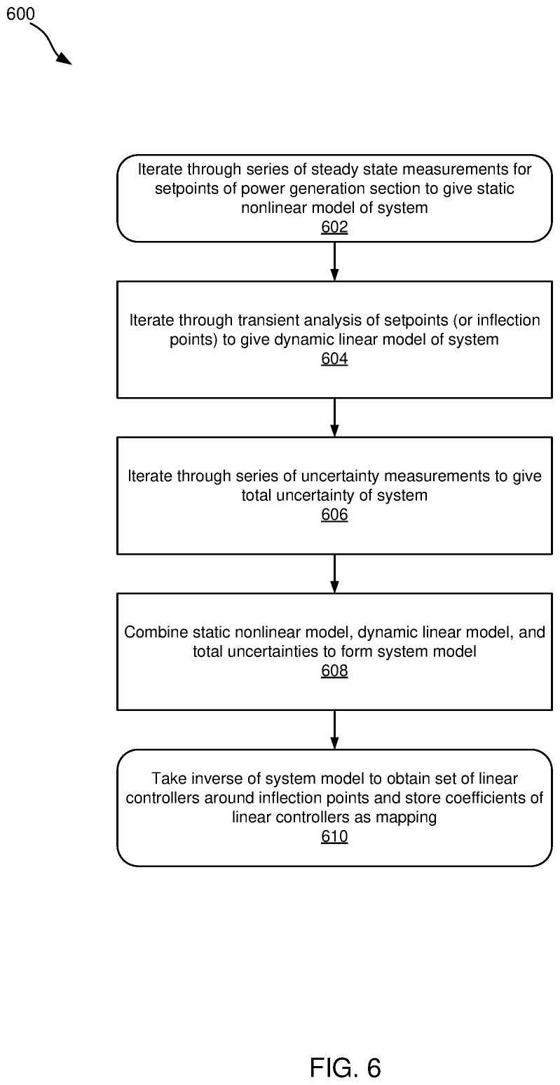

The controller 352 can use closed loop feedback from the sensors 314 and increase or decrease an output of the power generation section 314 based on the closed loop feedback. Alternatively, where a boundary controller 355 is used (see FIG. 6), the boundary controller 355 reduces or cuts off an output of the power generation section 314 if feedback from the sensors 314 meets or exceeds a threshold.

In use, the user interface 308 provides a target waveform or setpoints to the controller 352, which provides a control to the empirically derived mapping 354. The empirically derived mapping 354 passes the target waveform or setpoints through the coefficients of the linear controllers 358 to determine a modified control. If the target waveform or setpoints hit aspects of the system model 356 that are not adjacent to or covered by the coefficients of the linear controllers 358, then the interpolation function 360 can be used to determine a mapping for these points between the linear controllers 358. Thus, the operating regime is covered by the mapping comprising the linear controllers 358 and the interpolation function 360. The resulting modified control is provided to the power generation section 314 and used to control one or more actuators for driving a plasma load.

In an embodiment, the distributed controller 350 can include one or more processing portions, one or more memories, and one or more modules stored on the one or more memories and executable on the one or more processing portions to convert the target waveform or setpoint from the UI 308 to a control signal via a controller 352, such that the output signal from the power generation section 314 is stable. They can also be executable to convert the control signal from controller 352 to a modified control signal via an empirically derived mapping 354 between the control signal and a modified control signal and provide the modified control signal to the power generation section 314, such that the output signal from the power generation section 314 also rapidly converges to the target waveform or setpoint.

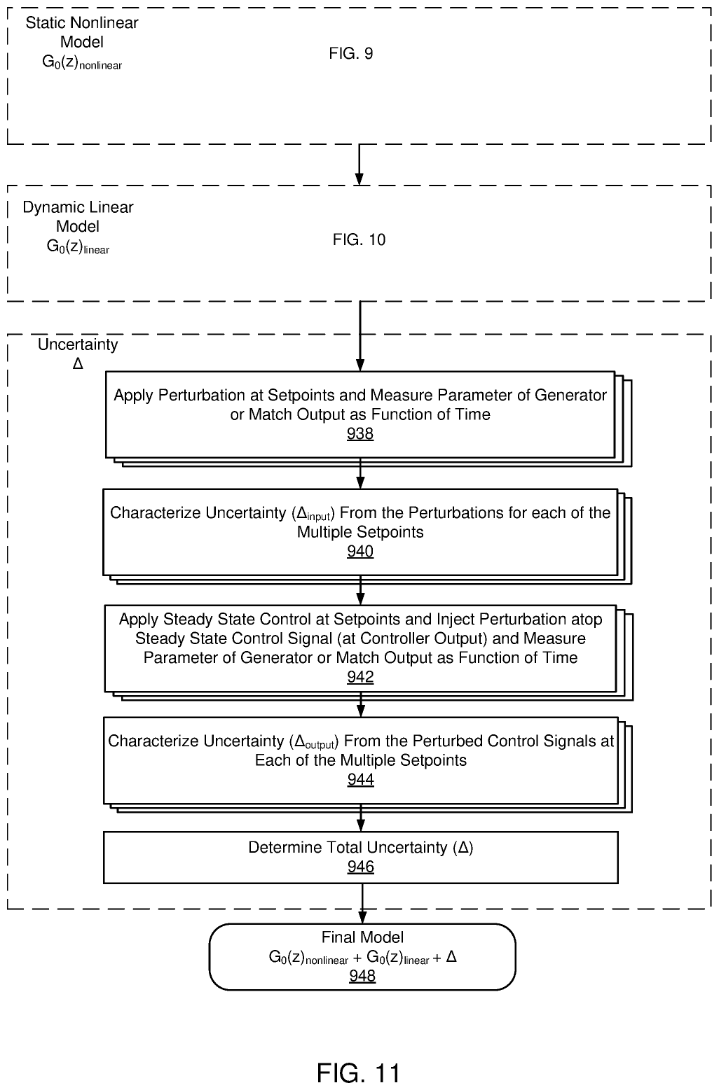

Development of the system model 356 is detailed in FIGS. 6-11.

FIG. 6 illustrates a method of creating a distributed controller. The method 600 can include iterating through a series of steady state measurements for setpoints of a power generation section to give a static nonlinear model of the system (Block 602). The method 600 can also include iterating through transient analysis of the setpoints, or inflection points identified in the static nonlinear model of the system, to give a dynamic linear model of the system (Block 604). The method 600 can then iterate through a series of uncertainty measurements to give a total uncertainty of the system (Block 606). Finally, the static nonlinear model of the system, the dynamic linear model of the system, and the total uncertainty can be combined (Block 608) to form a system model, such as the system model 356 in FIG. 5. This system model can underly operation of the distributed controller and be represented in a less-resource-intensive fashion, via coefficients of linear controllers around the inflection points (e.g., 358 in FIG. 5 along with the interpolation function 360). More specifically, the method 600 can take an inverse of the system model to obtain the set of linear controllers around the inflection points, and storing coefficients of the linear controllers as a mapping that the distributed controller is configured to call on during operation (e.g., at runtime) (610).

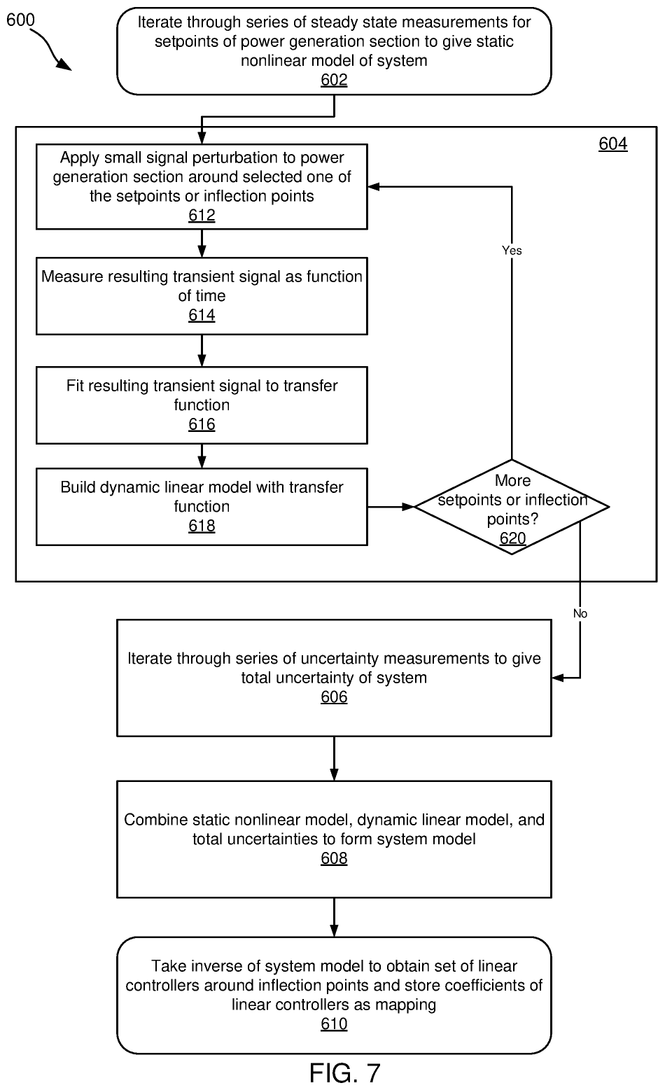

FIG. 7 presents possible additional details of development of the dynamic linear model (Block 604). This can include applying a small signal perturbation to the power generation section around a first of the setpoints (or inflection points if they have been identified) (Block 612). The resulting transient signal can be measured as a function of time (Block 614). The method can then fit the resulting transient signal to a transfer function (Block 616) and build out the dynamic linear model with the transfer function (Block 618). The method can then move to a next setpoint or inflection point (Decision 620=Yes), and the method can iteratively build out the dynamic linear model with this small signal analysis at all the setpoints or inflection points.

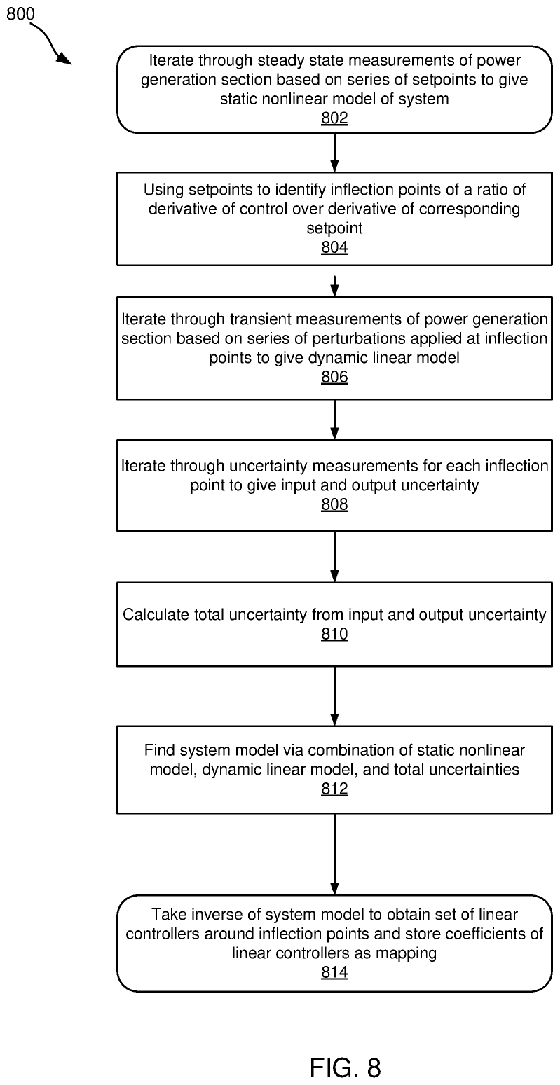

FIG. 8 illustrates another embodiment of a method for creating a distributed controller. The method 800 can include iterating through steady state measurements of a power generation section based on a series of setpoints to give a static nonlinear model of the system, G₀ (z)ₙₒₙₗᵢₙₑₐᵣ (Block 802) and then using the setpoints to identify inflection points (Block 804).

More specifically, the inflection points can be identified by finding a derivative of the control (e.g., output from 352 in FIG. 5) with respect to a corresponding setpoint that exceed a threshold (for linear interpolation between setpoints) and that exceed a function (for nonlinear interpolation between setpoints such as square, cubic, or spline). The method 800 then iterates through transient measurements of the power generation section based on a series of perturbations applied at the inflection points to give a dynamic linear model, G₀(z)ₗᵢₙₑₐᵣ, of the system (Block 806). The method 800 can then iterate through uncertainty measurements for each of the inflection points to give a total uncertainty formed from an input uncertainty, Δᵢₙ(z), and an output uncertainty, Δₒᵤₜ(z) (Block 808). Next, the total uncertainty is calculated from the input and output uncertainties for the inflection points (Block 810). The system model can be a combination of the static nonlinear model, the dynamic linear model, and the total uncertainties (Block 812). Finally, the distributed controller can be formed by coefficients of linear controllers around the inflection points, where the linear controllers are found as an inverse of a system model (Block 814). These coefficients can be stored in a memory of the distributed controller to form the empirically derived mapping (e.g., 354). The system model can be formed by the static nonlinear model of the system, G₀(z)ₙₒₙₗᵢₙₑₐᵣ, the dynamic linear model of the system, G₀(z)ₗᵢₙₑₐᵣ, and the total uncertainty.

Iterating through the uncertainty measurements (Block 808), can include, for each inflection point: perturbing one of the setpoints corresponding to one of the inflection points and applying a corresponding first control signal n times to the power generation section; measuring a parameter of an output of the power generation section as a function of time for each of the n corresponding first control signals to give n first measurements; characterizing the input uncertainty Δᵢₙ(z) for the one of the setpoints corresponding to one of the inflection points as a variance in the n measurements of the parameter of the output of the power generation section; applying a second control signal for one of the setpoints corresponding to the one of the inflection points and performing n identical perturbations of the second control signal; measuring a parameter of an output of the power generation section as a function of time for each of the n perturbed second control signals to give n second measurements; and characterizing the output uncertainty Δₒᵤₜ(z) for the one of the setpoints corresponding to one of the inflection points as a variance in the n second measurements.

Further, calculating the total uncertainty (Block 810), can include either of the following equations, where a and b are complementary weights that add to 1 and that the designer can apply to the input and output, uncertainty, respectively:

$$\frac{sum ( a {Δ}_{out} ( z ) + {{bG}_{0} ( z )}_{linear} {Δ}_{in} ( z ) )}{n} \qquad ( Equation 1 )$$

$$\frac{max ( a {Δ}_{out} ( z ) + {{bG}_{0} ( z )}_{linear} {Δ}_{in} ( z ) )}{n} \qquad ( Equation 2 )$$

Said another way, the total uncertainty is formed from (1) an input uncertainty developed by applying control signals corresponding to repeated perturbed setpoints to the power generator section and characterizing the input uncertainty from first resulting measurements, and (2) an output uncertainty developed by generating control signals from the controller corresponding to the setpoints and injecting a perturbation atop the control signals and characterizing the output uncertainty from second resulting measurements.

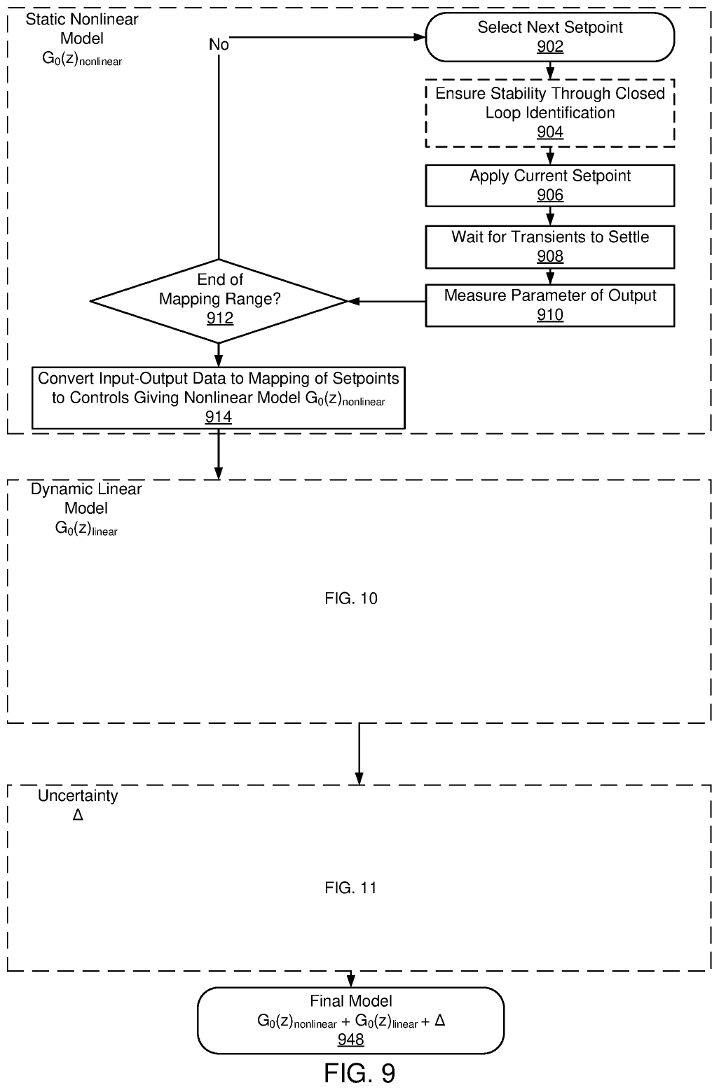

FIG. 9 illustrates an embodiment of a method for creating a system model. As discussed earlier, the system model can be converted to an empirically derived mapping to support operation of a distributed controller, by taking an inverse of the system model to form linear controllers around inflection points of the system model. The system model comprises a static nonlinear model, a dynamic linear model, and a total uncertainty, that can be combined to form the system model (Block 948). Each of these three sections of the system model (or “Final Model”) are detailed in FIGS. 9, 10, and 11. The static nonlinear model involves an iterative large signal analysis for steady state measurements at a series of setpoints. This can involve selection of a first setpoint (Block 902) followed by an optional step of ensuring stability through closed loop identification (Block 904). The current setpoint can be applied (Block 906), the method can wait for transients to settle (i.e., steady state (Block 908), and a measure of a parameter of the controller output can be measured (Block 910). If there are additional setpoints (Decision 912=No), then the method continues to iterate until all setpoints have been mapped to output measurements (Decision 912=Yes). The method then converts the acquired input and output data to a mapping of setpoints to controls, which gives the static nonlinear model (Block 914). This conversion may involve a time to frequency domain conversion, for instance, by taking a Fast Fourier Transform (FFT) of the input-output data in the time domain.

The optional closed loop identification means that the generator section output is generated by a controller that was designed ahead of time to ensure stability. The empirically derived mapping makes sure that the distributed controller can achieve optimal performance. So, the distributed controller is split into two parts, one to ensure stability and another to maximize performance.

In FIG. 10 one sees that the dynamic linear model is developed in a two-phase operation. First, small signal analysis along with derivatives is used to identify inflection points. Some of the original small signal analysis data is then tossed, or removed from memory, and then small signal analysis is performed on the inflection points and transfer function fitting is performed to build the dynamic linear model, one inflection point at a time. Gaps in the model, or areas that aren't adjacent to an inflection point, can be filled through linear interpolation.

More specifically, a first setpoint can be selected from the static nonlinear model developed in Blocks 902-914 (Block 916) and the setpoint can be perturbed and a measure of the transient response is performed (Block 918). These small signal perturbations can be iterated for all setpoints in the static nonlinear model (Decision 920=No), and then the method can identify inflections points in the transient measurements (Block 922). In particular, inflection points are identified by comparing a derivative of the control resulting form the perturbations around the series of setpoints with respect to the setpoint, to a threshold (when linear interpolation between inflection points is used). When nonlinear interpolation between inflection points is used, the comparing can be with respect to a function.

The dynamic nonlinear model may have too much data for the memory available, or it may take too long to process the data. Thus, optionally, the data set can be reduced by clearing or removing transient responses from memory except that data that is around or adjacent to inflection points (Block 924).

With inflection points identified, the method can then iterate through each inflection point, starting with a first inflection point (926) and perturb an input around a currently selected inflection point and measure a transient response (Block 928). The resulting data can be fit to a transfer function to build the dynamic linear model (Block 930). This small signal analysis can be repeated until a transfer function has been fitted to all of the inflection points (Decision 932=No).

Interpolation (Block 934) can be used to fill in gaps in the dynamic linear model.

Optionally, the dynamic linear model can be further optimized for storage and processing, by a compression (Block 936).

The method can also determine a total uncertainty via first determining an input and an output uncertainty. The method can apply a perturbation at the setpoints used to develop the static nonlinear model and measure a parameter of the generator or match output as a function of time (Block 938). This can be repeated multiple times using the same perturbation for each setpoint—in other words, trying to see how much the output varies given the same input perturbation. These measurements are taken as transients, and thus there is no need to wait for steady state. The method then characterizes the input uncertainty for each setpoint (Block 940) by looking at a variance of the transient signals across the multiple instances of perturbation for a given setpoint and repeating this analysis for all setpoints. This provides an input uncertainty mapping for each setpoint. Alternatively, Blocks 938 and 940 may be performed for inflection points, not all setpoints, in order to reduce processing and memory resources.

The output uncertainty can also be determined, and this can be done before, in parallel with, or after the input uncertainty is found. First, a control signal is applied at a setpoint until steady state is achieved. The perturbation from 938 is then injected at the output of the controller (atop the steady state control signal for the selected setpoint) and a measure of a parameter of the generator outputs is taken (Block 942). This is repeated for multiple instances of the injected perturbation, and for each setpoint. The output uncertainty is characterized in the same way as the input uncertainty, by looking at a variance of the transient signals across the multiple instances of injected perturbations for a given setpoint and repeating this analysis for all setpoints (Block 944). This provides an output uncertainty mapping for each setpoint.

The total uncertainty can be found (Block 946) as the sum or combination of the input and output uncertainties according to either of Equations 1 or 2.

The injected perturbation for the output uncertainty can be more easily understood via the following:

$$Total Control = Steady State Control - \frac{1}{( {{G}_{0} ( z )}_{nonlinear} + {{G}_{0} ( z )}_{linear} )} * ( setpoint + setpoint perturbation )$$

In other words

$$, the injection control = Total Control - Steady State Control . = Further , Total Control = ( Steady State Setpoint + Setpoint Perturbation ) * \frac{1}{F F T ( {{G}_{0} ( z )}_{nonlinear} + {{G}_{0} ( z )}_{linear} )}$$

Said another way, the total control for output perturbation (or injected perturbation) is:

Uₜₒₜₐₗ=u+uₚₑᵣₜ

where u is the control based on an open loop, and uₚₑᵣₜ is:

$${U}_{pert} ( z ) = \frac{{Output}_{pert} ( z )}{( {{G}_{0} ( z )}_{nonlinear} + {{G}_{0} ( z )}_{linear} )} = \frac{F F T ( {Output}_{pert} ( t ) )}{( {{G}_{0} ( z )}_{nonlinear} + {{G}_{0} ( z )}_{linear} )}$$

$${U}_{pert} ( t ) = I F F T ( {U}_{pert} ( z ) )$$

Where IFFT is the inverse Fast Fourier Transform. These equations are valid since G₀(z)ₙₒₙₗᵢₙₑₐᵣ+G₀(z)ₗᵢₙₑₐᵣ is stable and minimum-phase (i.e., stable zero dynamics) by definition through the design procedure.

Once the system or final model is determined (Block 948), the designer can take this model and carry out a controller design on the system model to approximate an inverse of the model in a stable and minimum-phase manner. This gives a set of simple linear controllers around each inflection point. The coefficient values of these linear controllers can be stored in the empirically derived mapping and used to determine a modified control whenever the control is at or adjacent to an inflection point. When the control signal falls in between these inflection points the interpolation function can be used to find the modified control signal. This interpolation may be tensorial interpolation since there may be several control values.

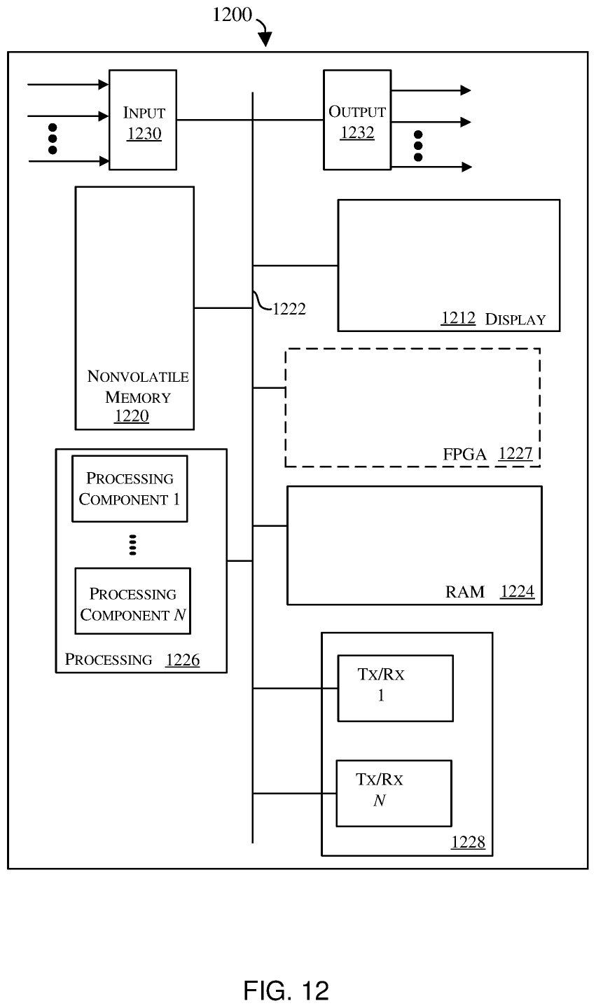

The methods described in connection with the embodiments disclosed herein may be embodied directly in hardware, in processor-executable code encoded in a non-transitory tangible processor readable storage medium, or in a combination of the two. Referring to FIG. 12 for example, shown is a block diagram depicting physical components that may be utilized to realize the distributed controller (and the controller section generally) according to an exemplary embodiment. As shown, in this embodiment a display portion 1212 and nonvolatile memory 1220 are coupled to a bus 1222 that is also coupled to random access memory (“RAM”) 1224, a processing portion (which includes N processing components) 1226, an optional field programmable gate array (FPGA) 1227, and a transceiver component 1228 that includes N transceivers. Although the components depicted in FIG. 12 represent physical components, FIG. 12 is not intended to be a detailed hardware diagram; thus many of the components depicted in FIG. 12 may be realized by common constructs or distributed among additional physical components. Moreover, it is contemplated that other existing and yet-to-be developed physical components and architectures may be utilized to implement the functional components described with reference to FIG. 12.

This display portion 1212 generally operates to provide a user interface for a user, and in several implementations, the display is realized by a touchscreen display. In general, the nonvolatile memory 1220 is non-transitory memory that functions to store (e.g., persistently store) data and processor-executable code (including executable code that is associated with effectuating the methods described herein). In some embodiments for example, the nonvolatile memory 1220 includes bootloader code, operating system code, file system code, and non-transitory processor-executable code to facilitate the execution of a method described with reference to FIGS. 2 and 3 described further herein.

In many implementations, the nonvolatile memory 1220 is realized by flash memory (e.g., NAND or ONENAND memory), but it is contemplated that other memory types may be utilized as well. Although it may be possible to execute the code from the nonvolatile memory 1220, the executable code in the nonvolatile memory is typically loaded into RAM 1224 and executed by one or more of the N processing components in the processing portion 1226.

The N processing components in connection with RAM 1224 generally operate to execute the instructions stored in nonvolatile memory 1220 to enable operation of a distributed controller. For example, non-transitory, processor-executable code to effectuate the methods described with reference to FIGS. 2 and 3 may be persistently stored in nonvolatile memory 1220 and executed by the N processing components in connection with RAM 1224. As one of ordinarily skill in the art will appreciate, the processing portion 1226 may include a video processor, digital signal processor (DSP), micro-controller, graphics processing unit (GPU), or other hardware processing components or combinations of hardware and software processing components (e.g., an FPGA or an FPGA including digital logic processing portions).

In addition, or in the alternative, the processing portion 1226 may be configured to effectuate one or more aspects of the methodologies described herein (e.g., the method described with reference to FIGS. 6-11). For example, non-transitory processor-readable instructions may be stored in the nonvolatile memory 1220 or in RAM 1224 and when executed on the processing portion 1226, cause the processing portion 1226 to perform a method of implementing a distributed controller designed by either the methods 600 or 800 or that shown in FIGS. 9-11. Alternatively, non-transitory FPGA-configuration-instructions may be persistently stored in nonvolatile memory 1220 and accessed by the processing portion 1226 (e.g., during boot up) to configure the hardware-configurable portions of the processing portion 1226 to effectuate the functions of the distributed controller or the control section 112 more generally.

The input component 1230 operates to receive signals (e.g., the target waveform or power setpoint) that are indicative of one or more aspects of the desired output of the generator 102. The signals received at the input component may include, for example, a target waveform or setpoint(s). The output component 1232 generally operates to provide one or more analog or digital signals to effectuate an operational aspect of the distributed controller or control section 112.

The depicted transceiver component 1228 includes N transceiver chains, which may be used for communicating with external devices via wireless or wireline networks. Each of the N transceiver chains may represent a transceiver associated with a particular communication scheme (e.g., WiFi, Ethernet, Profibus, etc.).

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The terms and expressions employed herein are used as terms and expressions of description and not of limitation, and there is no intention, in the use of such terms and expressions, of excluding any equivalents of the features shown and described or portions thereof. Each of the various elements disclosed herein may be achieved in a variety of manners. This disclosure should be understood to encompass each such variation, be it a variation of an embodiment of any apparatus embodiment, a method or process embodiment, or even merely a variation of any element of these. Particularly, it should be understood that the words for each element may be expressed by equivalent apparatus terms or method terms-even if only the function or result is the same. Such equivalent, broader, or even more generic terms should be considered to be encompassed in the description of each element or action. Such terms can be substituted where desired to make explicit the implicitly broad coverage to which this invention is entitled.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A generator comprising:
a power generation section;
a match network coupled to an output of the power generation section; and
a distributed controller configured to receive a target waveform and feedback from sensors at or downstream from the power generation section and/or the match network, the distributed controller comprising:
a controller configured to generate a control; and
an empirically derived mapping between an output of the controller and a modified control to be provided to the power generation section, the empirically derived mapping being an inverse of a system model comprising:
a static nonlinear model;
a dynamic linear model; and
a total uncertainty.

2. The generator of claim 1, wherein the controller uses closed loop feedback from the sensors and increases or decreases an output of the power generation section based on the closed loop feedback.

3. The generator of claim 1, wherein the controller forms an open loop controller and reduces or cuts off an output of the power generation section if feedback from the sensors meets or exceeds a threshold.

4. The generator of claim 1, wherein the static nonlinear model is derived from large signal steady state analysis.

5. The generator of claim 1, wherein the dynamic linear model is derived from small signal transient analysis.

6. The generator of claim 5, wherein the small signal transient analysis comprises:
applying first perturbations around a series of setpoints;
measuring first transient responses to the first perturbations;
identifying inflection points in the first transient responses;
applying second perturbations around the inflection points;
measuring second transient responses to the second perturbations; and
building the dynamic linear model by fitting the second transient responses to transfer functions.

7. The generator of claim 6, wherein the inflection points are identified by (1) comparing a derivative of the control resulting from the perturbations around the series of setpoints with respect to the setpoints to a threshold, when linear interpolation between the inflection points is used, or (2) comparing the derivative of the control resulting from the perturbations around the series of setpoints with respect to the setpoints to a function, when nonlinear interpolation between the inflection points is used.

8. The generator of claim 6, wherein the total uncertainty comprises (1) an input uncertainty developed by applying control signals corresponding to repeated perturbed setpoints, corresponding to the inflection points, to the power generation section and characterizing the input uncertainty from first resulting measurements, and (2) an output uncertainty developed by generating control signals from the controller corresponding to the setpoints, corresponding to the inflection points, and injecting a perturbation atop the control signals and characterizing the output uncertainty from second resulting measurements.

9. The generator of claim 1, wherein the total uncertainty comprises (1) an input uncertainty developed by applying control signals corresponding to repeated perturbed setpoints to the power generation section and characterizing the input uncertainty from first resulting measurements, and (2) an output uncertainty developed by generating control signals from the controller corresponding to the setpoints and injecting a perturbation atop the control signals and characterizing the output uncertainty from second resulting measurements.

10. A method of creating a distributed controller, the method comprising:
iterating through a series of steady state measurements for setpoints of a power generation section to give a static nonlinear model of a system that the distributed controller is configured to control;
iterating through transient analysis of the setpoints, or inflection points identified in the static nonlinear model of the system, to give a dynamic linear model of the system, and for each iteration of the transient analysis:
applying a small signal perturbation to the power generation section around a selected one of the setpoints or inflection points;
measuring a resulting transient signal as a function of time;
fitting the resulting transient signal to a transfer function;
building the dynamic linear model of the system with the transfer function; and
iterating through uncertainty measurements to give a total uncertainty of the system; and
combining the static nonlinear model of the system, the dynamic linear model of the system, and the total uncertainty to form a system model.

11. The method of claim 10, further comprising taking an inverse of the system model to obtain a set of linear controllers around the inflection points, and storing coefficients of the set of linear controllers as a first mapping that the distributed controller is configured to call on during operation.

12. The method of claim 11, wherein when operation of the distributed controller calls for a second mapping between the stored coefficients, interpolation is used to expand the first mapping to areas that are not adjacent to the inflection points.

13. The method of claim 10, further comprising building the dynamic linear model of the system via interpolation.

14. A method of creating a distributed controller, the method comprising:
iterating through steady state measurements of a power generation section based on a series of setpoints to give a static nonlinear model of a system, G₀(z)ₙₒₙₗᵢₙₑₐᵣ, controlled by the distributed controller;
using the setpoints to identify inflection points in the static nonlinear model of the system;
iterating through transient measurements of the power generation section based on a series of perturbations applied at the inflection points to give a dynamic linear model G₀(z)ₗᵢₙₑₐᵣ of the system;
iterating through uncertainty measurements for each of the inflection points to give a total uncertainty formed from an input uncertainty Δᵢₙ(z) and an output uncertainty Δₒᵤₜ (z);
calculating the total uncertainty from input and output uncertainties for the inflection points, wherein
the distributed controller comprises coefficients of linear controllers around the inflection points, where the linear controllers are found as an inverse of a system model comprising the static nonlinear model of the system G₀(z)ₙₒₙₗᵢₙₑₐᵣ, the dynamic linear model of the system G₀(z)ₗᵢₙₑₐᵣ, and the total uncertainty.

15. The method of claim 14, wherein iterating through the uncertainty measurements comprises for each one of the inflection points:
perturbing one of the setpoints corresponding to one of the inflection points and applying a corresponding first control signal n times to the power generation section;
measuring a parameter of an output of the power generation section as a function of time for each of the n corresponding first control signals to give n first measurements;
characterizing the input uncertainty Δᵢₙ(z) for the one of the setpoints corresponding to one of the inflection points as a variance in the n first measurements of the parameter of the output of the power generation section;
applying a second control signal for one of the setpoints corresponding to the one of the inflection points and performing n identical perturbations of the second control signal;
measuring a parameter of an output of the power generation section as a function of time for each of the n perturbed second control signals to give n second measurements; and
characterizing the output uncertainty Δₒᵤₜ(z) for the one of the setpoints corresponding to one of the inflection points as a variance in the n second measurements.

16. The method of claim 14, wherein calculating the total uncertainty comprises:
$$\frac{sum ( a {Δ}_{out} ( z ) + {{bG}_{0} ( z )}_{linear} {Δ}_{in} ( z ) )}{n}$$
$$\frac{max ( a {Δ}_{out} ( z ) + {{bG}_{0} ( z )}_{linear} {Δ}_{in} ( z ) )}{n}$$
Or
where a and b are weights applied to the input and output uncertainty, respectively.

17. A generator comprising:
a power generation section configured to apply an output signal to a load responsive to a setpoint;
one or more sensors coupled to, or coupled to an output of, the power generation section; and
a distributed controller comprising one or more processing portions, one or more memories, and one or more modules stored on the one or more memories and executable on the one or more processing portions to:
convert the setpoint to a control signal via a controller, such that the output signal is stable; and
convert the control signal to a modified control signal via an empirically derived mapping between the control signal and the modified control signal and provide the modified control signal to the power generation section, such that the output signal rapidly converges to the setpoint.

18. The generator of claim 17, wherein the empirically derived mapping is an inverse of a system model comprising:
a static nonlinear model;
a dynamic linear model; and
a total uncertainty.

19. The generator of claim 18, wherein the static nonlinear model is derived from iteratively applying setpoints to the power generation section, waiting for the output signal to reach a steady state, and then measuring a parameter of the output signal, thereby forming a mapping between setpoints and the output signal in steady state.

20. The generator of claim 18, wherein the dynamic linear model is derived from:
iteratively applying a small signal perturbation around the setpoints to the power generation section;
measuring first transient responses;
identifying inflection points in the first transient responses;
removing from memory the first transient responses that are not adjacent to an inflection point;
iteratively applying the small signal perturbation around the inflection points;
measuring second transient responses; and
fitting the second transient responses to transfer functions to build the dynamic linear model.
